(19) United States
(12) Patent Application Publication
(10) Pub. No.: US 2010/0038087 A1
(43) Pub. Date: Feb. 18, 2010

(54) EROSION MITIGATING APPARATUS AND METHOD

(75) Inventors: Torger Skillingstad, Bru (NO); Arthur H. Dybevik, Sandnes (NO)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 12/540,478

(22) Filed: Aug. 13, 2009

Related U.S. Application Data
(60) Provisional application No. 61/088,852, filed on Aug. 14, 2008.

(51) Int. Cl. E21B 43/24; E21B 43/00; E21B 43/16; E21B 17/00; B05B 1/26

(52) U.S. Cl. 166/302; 166/381; 166/242.1; 239/543

(57) ABSTRACT

Disclosed herein is an apparatus for injecting a fluid, the apparatus includes at least a plurality of nozzles arranged such that at least two of the nozzle streams impinge upon one another. Also disclosed herein is a method for injecting a fluid into a wellbore, the method includes at least: (1) providing an apparatus comprising a plurality of nozzles arranged such that at least two of the nozzle streams impinge upon one another; (2) installing the apparatus downhole; and (3) flowing the fluid through the apparatus.

### REFERENCE TO RELATED APPLICATIONS

This application claims priority to provisional patent application Ser. No. 61/088,852 filed on Aug. 14, 2008, incorporated herein by reference.

### BACKGROUND

In many areas of the world, large deposits of viscous petroleum exist, and these deposits are often referred to as “tar sand” or heavy oil” deposits due to the high viscosity of the hydrocarbons which they contain. These tar sands may extend for many miles and occur in varying thicknesses of up to more then 300 feet. Although tar sand deposits may lie at or near the earth's surface, generally they are located under a substantial overburden which may be as great as several thousand feet thick. Tar sands located at these depths constitute some of the world's largest presently known petroleum deposits. The tar sands contain a viscous hydrocarbon material, commonly referred to as a bitumen, in an amount which typically ranges from about 5 to about 20 percent by weight. While bitumen is usually immobile at typical reservoir temperatures, the bitumen generally becomes mobile at higher temperatures and has a substantially lower viscosity at higher temperature than at the lower temperatures.

Since most tar sand deposits are too deep to be mined economically, a serious need exists for an in situ recovery process wherein the bitumen is separated from the sand in the formation and produced through a well drilled into the deposit. Two basic technical requirements must be met by any in situ recovery process: (1) the viscosity of the bitumen must be sufficiently reduced so that the bitumen will flow to a production well; and (2) a sufficient driving force must be applied to the mobilized bitumen to induce production.

Hydrocarbon recovery may be enhanced in certain heavy oil and bitumen reservoirs by using steam assisted gravity drainage (SAGD). When using SAGD, horizontal production and steam injection wellbores are drilled into the hydrocarbon reservoir formations and steam is injected into the steam injection wellbore. The production and steam injection wellbores relatively are closely spaced in the vertical direction, and the injection of steam into the steam injection wellbore causes the heavy hydrocarbons in the production wellbore to become mobile due to the reduction of in situ viscosity. The benefits of SAGD over conventional secondary thermal recovery techniques include higher oil productivity relative to the number of wells employed and higher ultimate recovery of oil in place.

U.S. Pat. No. 6,988,549 discusses certain problems associated with typical SAGD projects. According to the '549 patent: (a) the economics of such projects is significantly impacted by the cost associated with generating steam; (b) SAGD does not typically employ the use of super-saturated steam because of the high cost of producing this steam with conventional hydrocarbon-fired tube boilers which results in using steam that is less efficient in transferring heat to the heavy oil reservoir; and (c) the produced water associated hydrocarbon production from these operations is typically disposed of in a commercially operated disposal well for a fee.

In addition, SAGD applications involving Limited Entry Perforation (LEP) inner strings may create erosion risk in the outer completion. Limited Entry Perforation systems use the pressure drop created by having limited ports or nozzles in a injection tubing to control and even out the injection fluids along the completion. These systems however have a erosion risk if the ports/nozzles are placed towards a outer steel completion and the steam/fluid rates are so high that erosive velocities are approached.

### SUMMARY

Disclosed herein is an apparatus for injecting a fluid, the apparatus comprising a plurality of nozzles arranged such that at least two of the nozzle streams impinge upon one another.

Also disclosed herein is a method for injecting a fluid into a wellbore, the method comprising: (1) providing an apparatus comprising a plurality of nozzles arranged such that at least two of the nozzle streams impinge upon one another; (2) installing the apparatus downhole; and (3) flowing the fluid through the apparatus.

### BRIEF DESCRIPTION OF THE DRAWINGS

FIG. 1 shows a schematic perspective drawing of an embodiment of an erosion resistant apparatus as described herein.

FIG. 2 shows a cross sectional view of an embodiment of an erosion resistant apparatus as described herein. The tubing midline is shown as reference number 110.

FIG. 3 shows a cross sectional view of an embodiment of an erosion resistant apparatus as described herein attached to other downhole components.

### DETAILED DESCRIPTION

It will be appreciated that the present invention may take many forms and embodiments. In the following description, some embodiments of the invention are described and numerous details are set forth to provide an understanding of the present invention. Those skilled in the art will appreciate, however, that the present invention practiced without those details and that numerous variations from and modifications of the described embodiments may be possible. The following description is thus intended to illustrate and not limit the present invention.

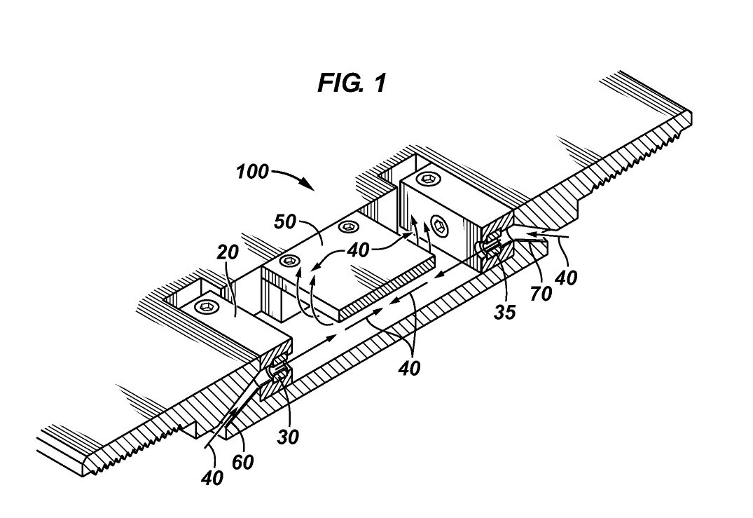

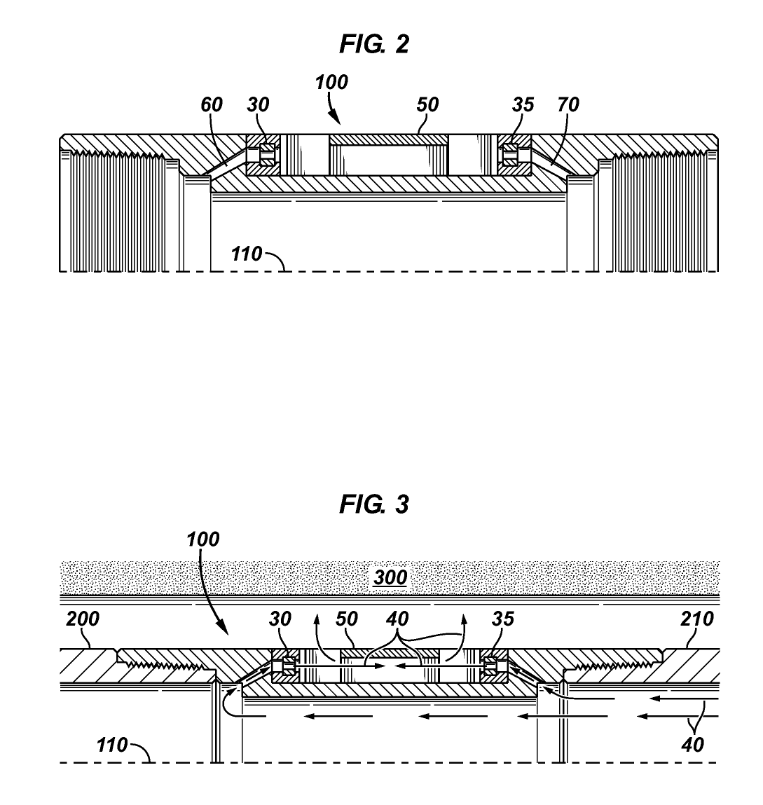

Referring now to FIG. 1, FIG. 2, and FIG. 3, there is shown a cross section of a sub for use in a downhole steam injection device. In operation, steam 40 is injected into ports 60 and 70 and through nozzles 30 and 35. Nozzles 30 and 35 are arranged in such a manner such that at least some of the energy of the steam 40 as it flows through nozzle 30 is dissipated and cancelled out by the steam that flows through nozzle 35. Likewise, the energy of the steam 40 that flows through nozzle 35 is at least partially dissipated and cancelled out by the steam that flows through nozzle 30. Additionally, optional protective cover 50 further prevents steam 40 from eroding elements outside of the erosion resistant sub 100.

Additionally, in FIG. 3, there is further shown other downhole components 200 and 210. Downhole components 200 and 210 may be attached to the upper and lower portions of the steam injection sub 100. The steam 40 is injected from the apparatus 100 into formation 300. In the drawings, it is shown that the steam injection sub 100 has two female or box ends. However, in some embodiments it is possible that both or either end could instead have a male or pin connection.

One embodiment may comprise a short steel section with standard box connections on each side where the flow through the bore is eccentric and there is flow ports going into an offset section where several nozzles are placed. The nozzles may be positioned such that the energy released gets cancelled out (e.g., Bernoulli equation principle where pressure drop through a nozzle is a function of the velocity at the exit of the nozzle).

In at least some embodiments, this apparatus system and method teaches a steam injection sub that mitigates or eliminates the erosion risk during steam injection in SAGD wells where a inner string (inside completion tubing) is used to control and even out the steam volumes in a horizontal steam injectors. Some current LEP systems have the drawback that the steam velocity is aimed directly (or at and angle) towards the outer tubing and if the steam velocity through the ports are high enough there is a risk of eroding a hole in the outher completion string/tubing. Using the steam injection system disclosed herein as part of the inner string steam assembly for the control of the steam injection can greatly reduce this erosion risks since the nozzles are not pointed directly towards the outer tubing. In some embodiments, the nozzles are pointed axially along the completion in offset area of the steam sub. In an embodiment having two nozzles, the nozzles may placed and configured so that a pair of nozzles are directly placed opposite each other (such as shown in FIG. 1) and therefore the energy release of increased velocity through the nozzles hits each other and cancel and dampens each other out before the steam then travel out through the sub and into the formation through the outer screen completion.

Although the embodiment shown in FIG. 1 shows two nozzles pointed directly at each other, it is envisioned that any arrangement of a plurality of nozzles arranged in such a manner that the streams exiting the nozzles interfere with each other in such a manner to mitigate the force of the stream and thus mitigate or eliminate the erosion of other components by the nozzle stream.

In addition, this system may be used in any application in which a nozzle stream may undesirably impinge upon another surface. For example in a flow control device.

We claim:

1. An apparatus for injecting a fluid, the apparatus comprising:
a plurality of nozzles arranged such that at least two of the nozzle streams impinge upon one another.

2. The apparatus of claim 1 wherein the fluid comprises steam.

3. The apparatus of claim 1 comprising at least three nozzles.

4. The apparatus of claim 1 further comprising a protective cover radially outward from the nozzles to dissipate the energy of the fluid.

5. The apparatus of claim 1 wherein the at least two nozzles inject fluid along the same axis.

6. The apparatus of claim 1 wherein the at least two nozzles inject fluid along different axes.

7. A method for injecting a fluid into a wellbore, the method comprising:
providing an apparatus comprising a plurality of nozzles arranged such that at least two of the nozzle streams impinge upon one another;
installing the apparatus downhole; and
flowing the fluid through the apparatus.

8. The method of claim 7 wherein the fluid comprises steam.

9. The method of claim 7 wherein the apparatus comprises at least three nozzles.

10. The method of claim 7 wherein the apparatus comprises a protective cover radially outward from the nozzles to dissipate the energy of the fluid.

11. The method of claim 7 wherein the at least two nozzles inject fluid along the same axis.

12. The method of claim 7 wherein the at least two nozzles inject fluid along different axes.

13. A downhole device comprising:
means for injecting fluid into a wellbore, the means for injecting comprising a means for dissipating the erosive potential of the fluid.

14. The means of claim 13 wherein the fluid comprises steam.

15. The means of claim 13 wherein the means for injecting comprises at least three nozzles.

16. The means of claim 13 wherein the means for dissipating comprises a protective cover radially outward from the means for injecting.

17. The means of claim 13 wherein the means for dissipating comprises at least two nozzles inject fluid along the same axis.

18. The means of claim 13 wherein the means for dissipating comprises at least two nozzles injecting fluid along different axes.
